(19) United States
(12) Patent Application Publication
(10) Pub. No.: US 2025/0012852 A1
(43) Pub. Date: Jan. 9, 2025

(54) INTEGRATED CIRCUIT SIMULATOR FOR DEGRADATION ESTIMATION AND TIME-OF-FAILURE PREDICTION

(71) Applicant: PROTEANTECS LTD., Haifa (IL)

(72) Inventors: Eyal FAYNEH, Givatayim (IL); Edi SHMUELI, Nesher (IL); Alexander BURLAK, Mountain Lakes, NJ (US); Evelyn LANDMAN, Haifa (IL); Inbar WEINTROB, Givat Ada (IL); Yahel DAVID, Kibbutz Gazit (IL); Shai COHEN, Haifa (IL); Guy REDLER, Haifa (IL)

(21) Appl. No.: 18/709,604

(22) PCT Filed: Nov. 15, 2022
(86) PCT No.: PCT/IL2022/051216

§ 371 Date: May 13, 2024

Related U.S. Application Data
(63) Continuation of application No. 17/703,438, filed on Mar. 24, 2022, now Pat. No. 11,740,281.
(60) Provisional application No. 63/279,373, filed on Nov. 15, 2021.

(51) Int. Cl. G01R 31/28

(52) U.S. Cl. CPC G01R 31/2853

(57) ABSTRACT

A method including: Receiving timing data of multiple data paths of an integrated circuit (IC) design. Simulating degradation of the multiple data paths over a period of time, wherein the timing data serve as a baseline of the simulated degradation, and wherein the simulation includes: simulating effects of operational conditions on the multiple data paths, wherein the operational conditions comprise: temperature, voltage, and frequency; simulating an effect of at least one physical degradation phenomenon on the multiple data paths, wherein the at least one physical degradation phenomenon is negative-bias temperature instability (NBTI), hot carrier injection (HCI), electromigration (EM), and/or time-dependent dielectric breakdown (TDDB); and simulating operation of a margin measurement circuit which is embedded in the IC design and monitors the multiple data paths, wherein the margin measurement circuit, in the simulated operation, outputs a time series of values of a worst-case remaining margin of the multiple data paths.

### CROSS-REFERENCE TO RELATED APPLICATIONS

This application claims priority to U.S. Provisional Patent Application No. 63/279,373, entitled “Integrated Circuit Simulator for Degradation Estimation and Time-of-Failure Prediction,” filed Nov. 15, 2021.

This application further claims priority to U.S. patent application Ser. No. 17/703,438, entitled “Integrated Circuit Degradation Estimation and Time-of-Failure Prediction Using Workload and Margin Sensing,” filed Mar. 24, 2022, which is a continuation-in-part of U.S. patent application Ser. No. 16/960,421, entitled “Integrated Circuit Workload, Temperature And/Or Sub-Threshold Leakage Sensor,” filed Jul. 7, 2020, which is a national phase of PCT Patent Application No. PCT/IL2019/050039, entitled “Integrated Circuit Workload, Temperature And/Or Sub-Threshold Leakage Sensor,” filed Jan. 8, 2019, which claims the benefit of priority of U.S. Provisional Patent Application No. 62/614,706, entitled “Integrated Circuit Sub-Threshold Leakage Sensor,” filed Jan. 8, 2018.

The contents of all the above applications are incorporated herein by reference in their entirety.

### BACKGROUND

The invention relates to the field of computerized simulation of integrated circuits, particularly of their aging.

Integrated circuits (ICs) may include analog and digital electronic circuits on a semiconductor substrate, such as a silicon wafer. Microscopic transistors are printed onto the substrate using photolithography techniques to produce complex circuits of billions of transistors in a very small area, making modern electronic circuit design using ICs both low cost and high performance. ICs are produced in assembly lines of factories, termed foundries, that have commoditized the production of ICs, such as complementary metal-oxide-semiconductor (CMOS) ICs.

Digital ICs contain billions of transistors arranged in functional and/or logical units on the wafer, with data paths interconnecting the functional units that transfer data values between the functional units. A data path typically includes, in fact, a parallel arrangement of multiple electronic connections (termed ‘bit paths’) for transferring data signals between the functional/logical units of an IC; each such data path may include a specific number of bit paths, such as 32, 64, 128, 256, or the like.

During the IC design process, the timing of the functional units is arranged so that each functional unit usually completes the required processing of that unit within a single clock cycle. A safety factor, often termed ‘margin,’ may be used to account for manufacturing differences of individual ICs and possible changes, such as degradations, over the planned lifetime of the IC.

The degradation of an IC's transistors and other components over time is termed ‘aging.’ For example, the degradation of transistors over time leads slowly to decreased switching speeds, and may even result in outright circuit failures, when they exceed the design safety factors. Usually, the design process incorporates these delays into the design such that the ICs will not fail during their normal lifetime, but environmental and usage conditions (such as increased temperature, voltage, current, humidity, and/or the like) may accelerate the aging process.

IC transistors, such as bipolar transistors, metal-oxide semiconductor field-effect transistors (MOSFETs), and/or the like, may be used in digital ICs and may function as electrical switches. For example, a MOSFET may have four terminals, such as the body, the gate, the source, and the drain, yet typically the source and body are electrically connected. The voltage applied to the gate may determine the amount of current that flows between the source and drain. A thin layer of dielectric material electrically insulates the gate, and the electric field applied across the gate may alter the conductivity of the underlying semiconductor channel between the source and drain.

Various physical degradation (aging) phenomena may affect IC transistors:

With use, charge carriers (such as electrons for n-channel MOSFETs, or holes for p-channel MOSFETs) that have more energy than the average charge carrier may stray out of the conductive channel between the source and drain, and become trapped in the insulating dielectric. This phenomenon, termed ‘hot-carrier injection’ (HCI), may eventually build up electric charge within the dielectric layer, and thus increase the voltage needed to operate the transistor. As the threshold voltage increases, the transistor switching delay may become larger.

Another degradation phenomenon, termed ‘bias temperature instability’ (BTI). occurs when voltage is applied to the gate. BTI may cause a buildup of charge in the dielectric, most of which spontaneously disappears after that gate voltage is removed. This recovery occurs within a few microseconds but leaves small, remaining effects that can be typically measured only after the stress is removed.

Yet another degradation phenomenon comes into play when voltage applied to the gate creates electrically-active defects, known as ‘traps,’ within the dielectric. When traps become too numerous, they may combine and form an outright short circuit between the gate and the current channel. This kind of failure is termed ‘oxide breakdown,’ or ‘time-dependent dielectric breakdown’ (TDDB). Unlike the other aging mechanisms, which cause a gradual decline in performance, the breakdown of the dielectric may lead to a catastrophic failure of the transistor, causing the IC to malfunction.

Additionally, a degradation phenomenon called ‘electromigration’ (EM) may damage the copper or aluminum connections that tie transistors together or link them to the outside world. Electromigration may occur when a surge of current knocks metal atoms loose from the electrical connections, and may cause them to flow with the electrons. This depletes the metal of some atoms upstream, while causing a buildup of metal downstream. The upstream thinning of the metal increases the electrical resistance of the connection, sometimes even becoming an open circuit. The downstream deposition may cause the metal to bulge out of its designated track.

Additionally, any manufacturing defect or unmodeled phenomenon may cause a timing degradation of a data path over time. Some defects may not even appear during testing, verification, initial operation, etc. For example, a via with a manufacturing defect, such as less than complete metal coverage, will increase its resistance over time and at some point cause a timing violation of a logic path. Furthermore, random manufacturing defects may appear anywhere on the IC and be manifested in a large variety of types and magnitudes, so designers may not be able to incorporate safety factors to mitigate these defects in advance.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment relates to a computer-implemented method comprising: receiving timing data of multiple data paths of an integrated circuit (IC) design; simulating degradation of the multiple data paths over a period of time, wherein the timing data serve as a baseline of the simulated degradation, and wherein the simulation comprises: (a) simulating effects of operational conditions on the multiple data paths, wherein the operational conditions comprise: temperature, voltage, and frequency, (b) simulating an effect of at least one physical degradation phenomenon on the multiple data paths, wherein the at least one physical degradation phenomenon is selected from the group consisting of: negative-bias temperature instability (NBTI), hot carrier injection (HCI), electromigration (EM), and time-dependent dielectric breakdown (TDDB), and (c) simulating operation of a margin measurement circuit which is embedded in the IC design and monitors the multiple data paths, wherein the margin measurement circuit, in the simulated operation, outputs a time series of values of a worst-case remaining margin of the multiple data paths.

Another embodiment relates to a system comprising: (a) at least one hardware processor; and (b) a non-transitory computer-readable storage medium having program code embodied therewith, the program code executable by said at least one hardware processor to: receive timing data of multiple data paths of an integrated circuit (IC) design; automatically simulate degradation of the multiple data paths over a period of time, wherein the timing data serve as a baseline of the simulated degradation, and wherein the simulation comprises: (i) simulating effects of operational conditions on the multiple data paths, wherein the operational conditions comprise: temperature, voltage, and frequency, (ii) simulating an effect of at least one physical degradation phenomenon on the multiple data paths, wherein the at least one physical degradation phenomenon is selected from the group consisting of: negative-bias temperature instability (NBTI), hot carrier injection (HCI), electromigration (EM), and time-dependent dielectric breakdown (TDDB), and (iii) simulating operation of a margin measurement circuit which is embedded in the IC design and monitors the multiple data paths, wherein the margin measurement circuit, in the simulated operation, outputs a time series of values of a worst-case remaining margin of the multiple data paths.

A further embodiment relates to a computer program product comprising a non-transitory computer-readable storage medium having program code embodied therewith, the program code executable by at least one hardware processor to: receive timing data of multiple data paths of an integrated circuit (IC) design; automatically simulate degradation of the multiple data paths over a period of time, wherein the timing data serve as a baseline of the simulated degradation, and wherein the simulation comprises: (i) simulating effects of operational conditions on the multiple data paths, wherein the operational conditions comprise: temperature, voltage, and frequency, (ii) simulating an effect of at least one physical degradation phenomenon on the multiple data paths, wherein the at least one physical degradation phenomenon is selected from the group consisting of: negative-bias temperature instability (NBTI), hot carrier injection (HCI), electromigration (EM), and time-dependent dielectric breakdown (TDDB), and (iii) simulating operation of a margin measurement circuit which is embedded in the IC design and monitors the multiple data paths, wherein the margin measurement circuit, in the simulated operation, outputs a time series of values of a worst-case remaining margin of the multiple data paths.

In some embodiments, the computer-implemented method further comprises, or the program code is further executable for: based on the simulated degradation, estimating at least one of: a degradation curve of the multiple data paths over the period of time, and a predicted time of failure of the IC design due to a timing violation by a worst-performing data path of the multiple data paths.

In some embodiments, the margin measurement circuit comprises: a signal combiner configured to combine signals from the multiple data paths; a signal splitter configured to split the combined signals into two test paths; a delay circuit configured to gradually apply varying levels of delay to signals passing through a first one of the two test paths; a comparation circuit configured to determine the worst-case remaining margin of the multiple data paths, based on a comparison between the first test path and a second one of the two test paths.

In some embodiments, the computer-implemented method further comprises, or the program code is further executable for: receiving values of the operational conditions from a user.

In some embodiments, the receiving of the values of the operational conditions receiving comprises: receiving different values of at least one of the operational conditions, and receiving a selection of different points in time, during the period of time, at which the different values, respectively, are to be applied; and the computer-implemented method further comprises, or the program code is further executable for, applying the different values at the selected different point in time during the simulation of the operational conditions.

In some embodiments, the computer-implemented method further comprises, or the program code is further executable for: receiving a selection of the at least one physical degradation phenomenon from a user, wherein the simulating of the effect of the at least one physical degradation phenomenon is based on the selection.

In some embodiments, the selection of the at least one physical degradation phenomenon comprises: a selection of multiple ones of the physical degradation phenomena, and a selection of different points in time, during the period of time, at which each of the multiple ones of the physical degradation phenomena, respectively, is to be applied; and the computer-implemented method further comprises, or the program code is further executable for, applying the multiple ones of the physical degradation phenomena at the selected different point in time during the simulating of the effect of the multiple ones of the physical degradation phenomena.

In some embodiments, the values of the worst-case remaining margin, which are output by the margin measurement circuit, are each given as a range of worst-case remaining margins.

In some embodiments, the simulation of the degradation further comprises: simulating execution by the IC of different software applications at different times, by periodically adjusting one or more margin values of one or more of the multiple data paths, respectively.

In some embodiments, the computer-implemented method further comprises, or the program code is further executable for, based on the simulated degradation: adjusting one or more of the multiple data paths in the IC design, to increase or decrease the margin of the one or more data paths.

In some embodiments, the computer-implemented method further comprises, or the program code is further executable for, based on the simulated degradation: receiving data from a margin measurement circuit embedded in an operating IC that was fabricated according to the IC design; and based on the simulated degradation and on the received data, performing at least one of: estimating deviation of actual degradation of the operating IC from the simulated degradation, updating a degradation estimation of the operating IC, and issuing an alert based on an estimated deviation of actual degradation of the operating IC from the simulated degradation.

In some embodiments, the computer-implemented method further comprises, or the program code is further executable for: in a Dynamic Voltage and Frequency Scaling (DVFS) system of an IC fabricated according to the IC design, configuring parameters of the DVFS system based on the simulated degradation.

In some embodiments, the configuring of the parameters is performed: between when the IC is fabricated and when the IC is released for field operations; and/or during field operation of the IC, at a time determined in advance based on the simulated degradation.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of an exemplary system for IC degradation simulation, according to an embodiment.

FIG. 2A is an illustration of an exemplary graphical user interface (GUI) of a degradation simulator, according to an embodiment.

FIG. 2B is another illustration of the exemplary GUI of FIG. 2A, according to an embodiment.

FIG. 3 is a flowchart of a method for simulating degradation of an IC, according to an embodiment.

### DETAILED DESCRIPTION

Disclosed herein is a method, system, and computer program product for simulating degradation of an IC. The simulated degradation may then be used, for example, to provide a degradation curve of the IC over time, a predicted time of failure of the IC, and/or to augment margin measurements of ICs operating in the field.

The simulation may also aid in a design process of the IC, such as to improve the design prior to fabrication of ICs according to the design. The simulation may additionally aid in classification and purposing of ICs fabricated according to the design, so that these ICs may be directed to purposes suitable for their estimated degradation and predicted time of failure. Another possible use of the simulation is to determine (and configure, in ICs fabricated according to the design) a suitable power management scheme for the IC, such as parameters (e.g., voltage and frequency) of a DVFS (Dynamic Voltage and Frequency Scaling) system, to meet a certain lifetime target of the IC. Configuring a fabricated IC's DVFS system parameters may take place between when the IC is fabricated and when it is released for field operation (namely, before it is delivered to an end user who will operate it in the field), and/or during the field operation of the IC, at a time determined in advance based on the simulated degradation. For example, these parameters may be configured to initially permit high performance of the IC (with the tradeoff of causing faster degradation), and then re-configured, at one or more times during the field operation of the IC, to lower the IC's performance in order to slow down its degradation. Other configuration schemes are also possible, such as configuring the DVFS system parameters at multiple times (before the IC is released to field operation and/or during field operation) so that the IC's performance remains consistent despite its gradual degradation.

The simulation may be based on results of static timing analysis (STA) of multiple data paths of an IC design, or on any similar timing data of the data paths. These may be data paths determined to be critical paths, for example.

Then, given the timing data, the degradation of the multiple data paths over the period of time may be simulated by: Simulating an effect of operational conditions, such as temperature, voltage, and/or frequency, on the multiple data paths; simulating an effect of at least one physical degradation phenomenon, such as NBTI, HCI, EM, and/or TDDB, on the multiple data paths; and simulating operation of a margin measurement circuit which is embedded in the IC design and configured to monitor the multiple data paths. This margin measurement circuit, in its simulated operation, outputs a time series of values of a worst-case remaining margin of the multiple data paths, namely—the narrowest margin among these paths.

Essentially, since the margin measurement circuit is set up to output the narrowest margin among the data paths it monitors, and since the simulation takes into account the effect of the operational conditions and physical degradation phenomena on the data paths, the output of the margin measurement circuit may be indicative of degradation of these data paths given these effects. This output may be used, for example, to estimate a degradation curve of the data paths over the period of time, and/or to predict a time of failure of the IC due to a timing violation by the worst-performing data path.

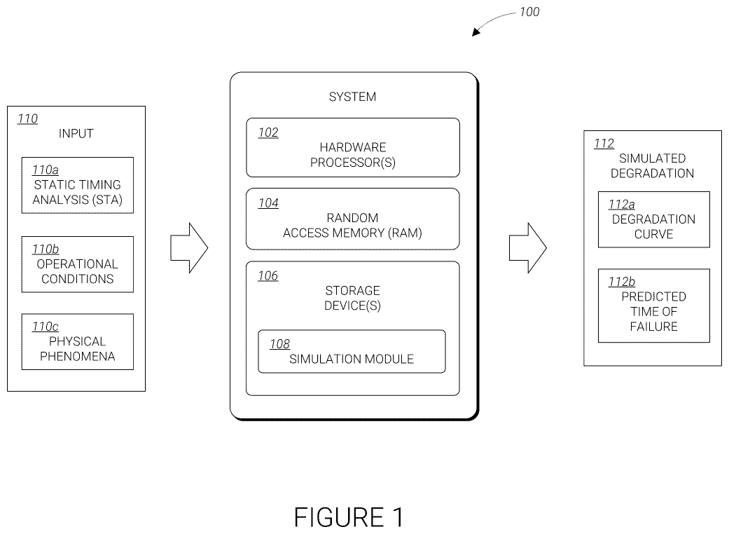

Reference is now made to FIG. 1, which shows a block diagram of an exemplary system 100 for IC degradation simulation, according to an embodiment. System 100 may include one or more hardware processor(s) 102, a random-access memory (RAM) 104, and one or more non-transitory computer-readable storage device(s) 106.

Storage device(s) 106 may have stored thereon program instructions and/or components configured to operate hardware processor(s) 102. The program instructions may include one or more software modules, such as a simulation module 108. The software components may include an operating system having various software components and/or drivers for controlling and managing general system tasks (e.g., memory management, storage device control, power management, etc.), and facilitating communication between various hardware and software components.

System 100 may operate by loading instructions of simulation module 108 into RAM 104 as they are being executed by processor(s) 102. The instructions of simulation module 108 may cause system 100, in a general sense, to receive input 110 such as STA results 110a, operational conditions selection 110b, and physical phenomena selection 110c, process the input by way of simulation, and output a simulated degradation 112 of the pertinent IC, including a degradation curve 112a and/or a predicted time of failure 112b.

System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. System 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 100 may be co-located or distributed, or the system may be configured to run as one or more cloud computing “instances,” “containers,” “virtual machines,” or other types of encapsulated software applications, as known in the art.

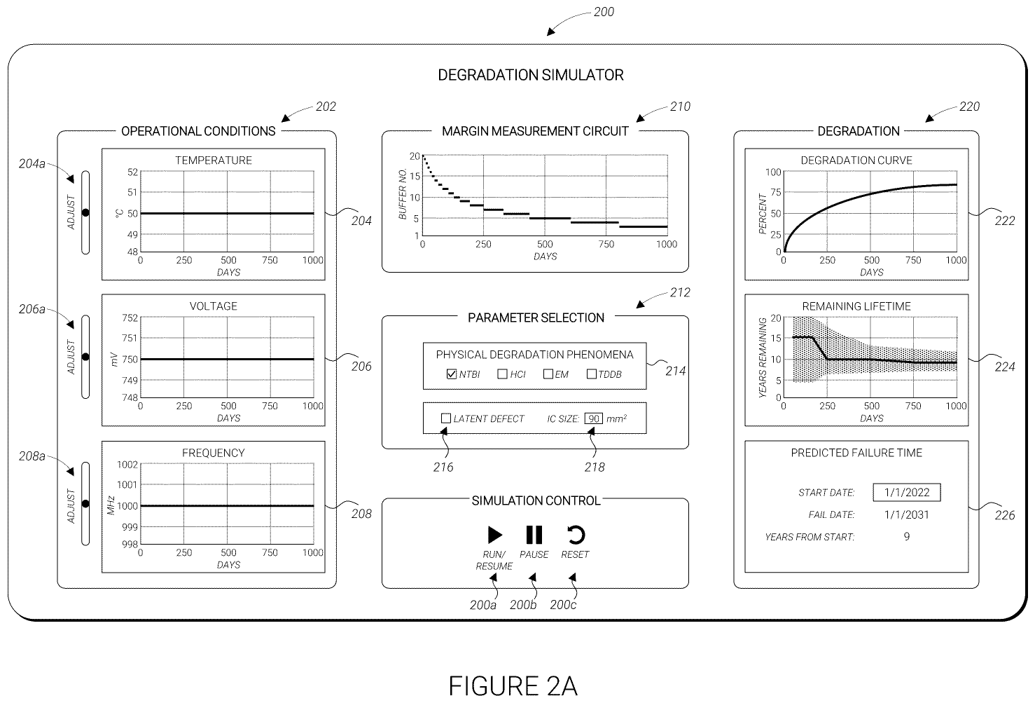

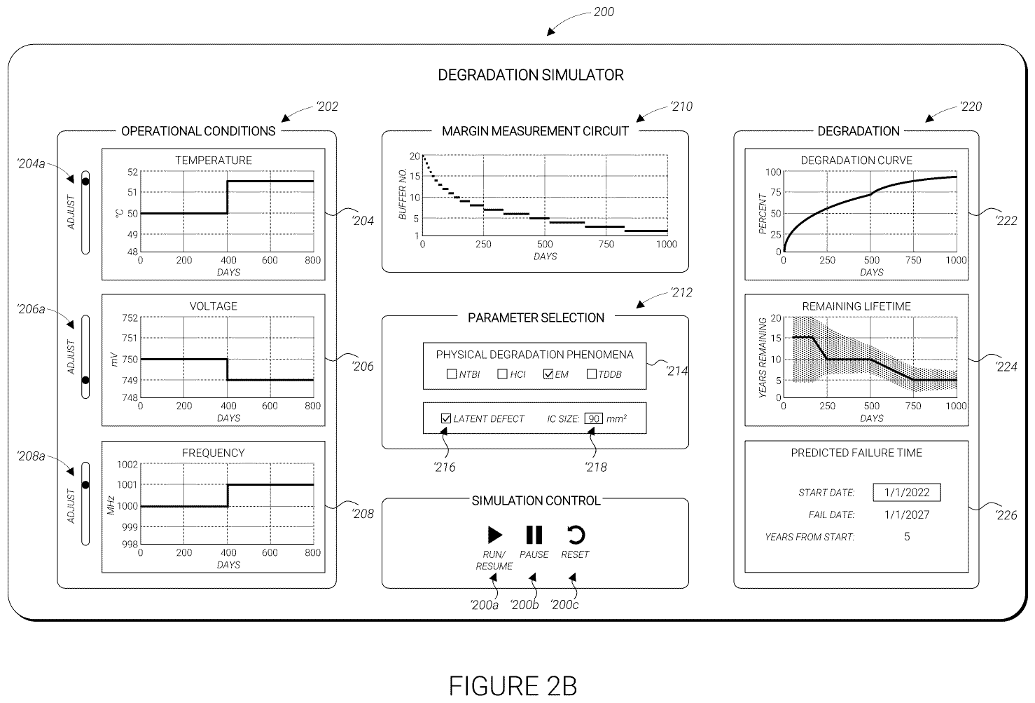

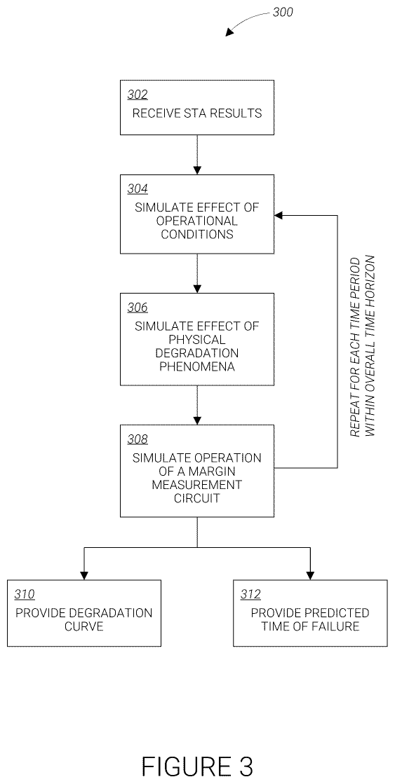

The instructions of simulation module 108 are now discussed with reference to an exemplary graphical user interface (GUI) 200 of a degradation simulator, illustrated in FIG. 2A, and to a flowchart of a method 300 for simulating degradation of an IC (or more specifically, of critical paths of the IC), illustrated in FIG. 3. GUI 200 may enable a user of method 300 to provide input to simulation module 108 (of FIG. 1) and to observe output of the module. The user may use controls such as a run/resume control 200a, a pause control 200b, and/or a reset control 200c to affect respective actions with regard to the simulation.

Steps of method 300 may either be performed in the order they are presented or in a different order (or even in parallel), as long as the order allows for a necessary input to a certain step to be obtained from an output of an earlier step. In addition, the steps of method 300 are performed automatically (e.g., by system 100 of FIG. 1), unless specifically stated otherwise.

Generally, to produce a simulation spanning a certain period of time (also referred to as a ‘time horizon’), method 300 may be repeated (iterated) for each of smaller periods of time. For example, method 300 may be repeated for each single day of simulation, to result in an overall simulation spanning a time horizon of hundreds, thousands, or even tens of thousands of days. Similarly, a user of method 300 may set its iteration period to any desired value, such as one hour, a few hours, a day, a few days, a week, a few weeks, a month, a few months, and so on and so forth. The length of the time horizon may either be decided in advance, or, more typically, the simulation may continue until an indication that the simulated IC has failed due to a timing violation in one (or more) of its data paths, or until the simulation has been lengthy enough to deduce, at a high degree of confidence, when such timing violation is likely to occur.

For a better understanding of the simulation of method 300, reference is first made, intentionally, to one of the last steps of this method, step 310, in which operation of a margin measurement circuit is simulated. As briefly mentioned above, the margin measurement circuit is embedded in the IC design (also with the goal of having it fabricated with the IC) to monitor the multiple data paths. Once every predefined period of time (corresponding to one iteration over method 300), the margin measurement circuit outputs a value of the worst-case remaining margin of the data paths. For example, this may happen once a day, to serve as a measurement of that worst-case remaining margin following the activity of the data paths during that day. The simulation may progress this way on a day-by-day by basis, for example, to output a time series of the worst-case remaining margin values over a longer time horizon, such as hundreds or thousands of days.

With interim reference to FIG. 2A, such exemplary time series is graphically illustrated in a margin measurement circuit panel 210, showing readings of the margin measurement circuit over an exemplary period of a 1000 days, with a reading (a value) once a day.

The margin measurement circuit which outputs these readings may be identical or similar the timing delay margin measurement circuit or related devices/circuits disclosed in PCT International Publication No. WO2019/097516, entitled “Integrated Circuit Margin Measurement and Failure Prediction Device,” which is incorporated herein by reference. Generally, the margin measurement circuit may include the following main components: A signal combiner configured to combine signals from the multiple data paths into a single signal; a signal splitter configured to split the combined signal into two test paths; a delay circuit configured to gradually apply varying levels of delay to signals passing through a first one of the two test paths; a comparation circuit configured to determine the worst-case remaining margin of the multiple data paths, based on a comparison between the first test path and a second one of the two test paths performed at every level of delay.

The term “worst-case” is used here to denote the narrowest (lowest) remaining margin among the multiple data paths. Because signals from the data paths are combined, it may be impossible to know the individual remaining margin of each of these data paths. Instead, the output of the margin measurement circuit may be indicative of the narrowest margin existing among the data paths. This knowledge is typically sufficient, because if even a single critical path fails due to a timing violation, the entire IC may become effectively inoperative.

In some embodiments, for practical reasons, the values output by the margin measurement circuit may be of a relatively low resolution, namely—they may not indicate a precise remaining margin in units of time (e.g., picoseconds), but rather each indicate a range of margins within which the currently-measured remaining margin falls. For example, the margin measurement circuit may be configured to output a serial number of a certain buffer it includes, wherein this buffer encapsulates and indicates a certain range of margin time values. For instance, if the margin measurement circuit includes 20 such buffers, which overall encapsulate 200 picoseconds of margin, then these buffers may encapsulate the following margins measured by the circuit:

TABLE 1
Margin range encoding by the margin measurement circuit's buffers

| Buffer number | Margin range (in picoseconds) |
|---|---|
| 1 | 0.1 (or exactly 0)-10 |
| 2 | 10.1-20 |
| . . . | |
| 20 | 190.1-200 |

In the above example, each buffer can be indicative of a margin within a 10-picosecond range. In various embodiments, however, the overall number of buffers, the range per margin, and the resulting overall margin coverage of all buffers may be different. These may be decided upon by the chip designer, who chooses a desired margin for the various data paths in the IC, and configures/designs a margin measurement circuit accordingly. For instance, the overall margin coverage of all buffers (namely, of the margin measurement circuit as a whole) may be in the range of 50-500 picoseconds; this broad range is intended to include any sub-range included therein (e.g., 50-100, 70-300, 400-500, 100-300, etc.) even if such sub-range is not explicitly listed here for reasons of brevity. The number of buffers may be, for instance, between 2 and 100, according to a desired measurement resolution; this broad range is intended to include any sub-range included therein (e.g., 2-20, 5-20, 10-20, 5-30, 10-30, etc.) even if such sub-range is not explicitly listed here for reasons of brevity.

The time series of values which is output when the operation of the margin measurement circuit is simulated may be expressed as buffer serial numbers, shown at the Y axis of margin measurement circuit panel 210, and day numbers, shown at the X axis of that panel.

Step 308, in which the margin measurement circuit is simulated, can be seen as a culmination of method 300. That is, each value in the time series output by this simulation is in fact the result of the multiple factors that have affected the degradation of the monitored data paths in the preceding time period (e.g., a day), namely—the operational conditions, the physical degradation phenomena, and optionally also the size of the IC, the existence of latent defects, etc. These factors are discussed below with reference to steps 304-306 of method 300.

However, before the simulation begins, an initial step 302 of method 300 (which may not be part of the iteration over the other steps) may be to receive timing data of the multiple data paths of the IC design, such as a margin value (in units of time, such as picoseconds) for each of these data paths. The timing data is optionally the result of a static timing analysis (STA), which is a known simulation method of computing the expected timing of a digital circuit without requiring a simulation of the full circuit. Optionally, but not necessarily, the STA is performed as a step of method 300. It is also possible to utilize STA results of data paths not of the particular IC design, but which are known to behave similarly, such as from previous versions of that design.

The timing data received in step 302 may essentially be a list of the initial (i.e., before the IC begins to first operate in the field) margins of the multiple data paths, given in picoseconds or other units of time. For instance, if a certain margin measurement circuit monitors 32 data paths, the STA results may include 32 numerical margin values. It may also be possible, for simplification purposes, to accept as input only a single one of these values, which is the lowest of all values; this simplification technique assumes that the data path with the lowest margin will also be the one whose degradation is always the worst.

It may also be possible, in step 302, to utilize an arbitrary list of data path margins which is not the result of real STA. This may enable an IC designer to test various hypotheses as to the effect of different margin values of certain data paths on the IC's potential degradation. The designer may simulate, for example, different sets of data path margins (either provided manually or by some randomization algorithm), to determine which of these sets is most preferable and should dictate parameters of the IC design (such as component sizes which affect margin). A further option is for the designer to provide a margin range for each data path, and to have method 300 automatically repeat as many times as necessary to simulate based on discrete values within each provided range. For example, if a margin range of 200-300 picoseconds is provided for a certain data path, method 300 may automatically be repeated for discrete margin values such as 200, 210, 220, . . . , 300, or at different increments determined by the designer. Another option is execution of method 300 based on automatic, random selection of multiple discrete margin values within the provided range(s).

Another option in step 302 is to receive a list of data path margins which were determined by an IC tester—a device which physically connects to an IC, post fabrication, to test the IC's operation.

Yet another option is step 302 is to receive a list of data path margins from an IC already operating in the field. These data path margins may be collected from the IC at its initial stage of operation (e.g., in the first few hours, days, or weeks of its operation), so that they reliably indicate these paths' starting point.

Whichever of the aforementioned options is utilized, the margin values received in step 302 may serve as the starting point (or ‘baseline’ for a timing margin range) of the simulation performed in subsequent steps of method 300.

Then, given the STA results, the degradation of the multiple data paths over a time horizon may be simulated by iterating over the following steps a desired number of times, or until the simulation indicates a timing violation that renders the IC inoperable:

In a step 304, an effect of operational condition(s) on the multiple data paths may be simulated. The operational conditions may include one or more of temperature, voltage, and frequency. As to temperature, this may be the temperature that would have theoretically been measured by a temperature sensor embedded in the IC, typically (but not necessarily) in the vicinity of the data paths. Integrated circuits tend to heat up during operation, and reach temperatures of, typically, 40-100° C. or beyond. As to voltage, this may be the core voltage of the IC (often termed V_{CORE}), which is typically in the range of 0.9-1.3 Volts or beyond. As to frequency, this may be the clock frequency of the IC or of a processor being part of the IC, which is typically in the range of up to a few GHz. Of course, the present invention may also function for operational conditions exceeding these values, such as conditions that will be enabled as semiconductor and microelectronic technologies advance.

The simulation of step 304 may be based on effects known from the semiconductor and microelectronic device literature of such operational condition(s) on microelectronic parts of the type of the multiple data paths, and of course given the specific timing data of the IC under simulation.

The output of step 304, for each iteration over method 300, may be a certain acceleration factor which denotes by how much the data paths have degraded during the time period of the iteration (e.g., a single day) given the operational condition(s) existing on that day on average. The acceleration factor may be determined, for example, based on a separate simulation of the data paths (or their representation, such as of a typical CMOS) in an electronic circuit simulator such SPICE (Simulation Program with Integrated Circuit Emphasis), or the like. The output of such separate simulation may be received as optional, additional input to method 300. With reference to FIG. 2A, an operational conditions panel 202 may allow viewing, as well as adjusting, a temperature 204, a voltage 206, and a frequency 208. In the simplistic example shown, these three operational conditions have remained constant along the simulated time horizon of 1000 days. However, by adjusting one or more of these operational conditions during the simulation, more complex scenarios may be evaluated, such as of an IC that operates under different operational conditions during different smaller periods of time within the overall simulated time horizon. For instance, a user may pause 200b the simulation after a certain number of simulated days, and use any of sliders 204a, 206a, and/or 208a to adjust the temperature, voltage, and/or frequency, respectively. Then, the user may resume 200a the simulation, which will now be effected given the newly-adjusted operational parameter(s). Of course, the pausing 200b and resuming 200a of the simulation are only provided for the user's convenience, and the user may choose not to use these functionalities but rather adjust the operational condition(s) on the fly, as the simulation is running; in this case, the new operational conditions(s) will simply apply starting with the next simulated time period (e.g., day), which is the next iteration of method 300.

Sliders 204a, 206a, and 208b of FIG. 2A are merely shown as a simplistic example of how method 300 may receive values of the operational condition(s). Such values may of course be received by more sophisticated means, such as by programming method 300 (optionally, in programming it in advance) to adjust any of these condition(s) at one or more certain iterations over the method.

In a step 306, an effect of at least one physical degradation phenomenon on the multiple data paths may be simulated. These physical degradation phenomena may include negative-bias temperature instability (NBTI), hot carrier injection (HCI), electromigration (EM), and time-dependent dielectric breakdown (TDDB), and any other related phenomena known in the microelectronics physics-of-failure (PoF) literature. Each such physical degradation phenomenon has its own typical temporal pattern, usually a certain non-linear degradation curve delineating the rate at which microelectronic, semiconductor components gradually break down. It should be noted that, while some physical degradation phenomena may be expressed in the output of margin measurement circuit [add number] (e.g, NBTI, HCI, and EM), others (e.g., TDDB) may not influence the margin and hence not affect the output of the margin measurement circuit.

With reference to FIG. 2A, inside a parameters selection panel 212, a physical degradation phenomena panel 214 may enable a user to select one or more phenomena whose simulation at step 306 is desired. The user may either let his or her initial selection (e.g., as shown, NTBI) apply to the entirety of the simulation's time horizon, or change this selection during the simulation, such as by pausing 200b the simulation, adjusting the selection, and resuming 200a the simulation. The adjustment may also be done without pausing and resuming but rather on the fly, as discussed above with reference to step 304.

Optionally, a graph visualizing the effect of the selected physical degradation phenomenon may be displayed to the user (this is not shown in FIG. 2A). This may enable the user to understand the contribution of the selected phenomenon to the overall degradation, separately from the information displayed in degradation panel 220 (further described below).

Further in parameters selection panel 212, a user may select to simulate a latent defect 216 (or a plurality of such defects) existing in the IC. Latent defects are random fabrication defects that typically come to play not immediately, but rather after the IC has been active for a while (e.g., a few weeks, months, or years). When a latent defect begins influencing a certain data path of the IC, it usually causes rapid, exponential degradation. Merely as an example, a weak short circuit may initially have very high resistance, thus not affecting the data path's operation at all. However, that resistance may suddenly begin to drop exponentially, quickly leading to complete failure of that data path's ability to operated. Accordingly, a user may check the latent defect 216 box at a certain time during the simulation, which will in turn begin to exponentially affect degradation. This may be done with or without pausing and resuming the simulation, similar to what was discussed above.

Further in parameters selection panel 212, a user may input a size 218 of the IC (e.g., in square millimeters). This may enhance the simulation of one or more of the physical phenomena. For example, in some relatively recent fabrication processes, TDDB is affected also by the overall size of the IC. This effect, as known in the art, may be factored in the simulation, given the user's input of the IC's size.

Not shown in FIG. 2A but certainly an option, a user may, at any time during the simulation, adjust the instantaneous margin values of the multiple data paths. This may be useful if the user desires to also simulate different software applications executed by the IC (typically, a CPU or a GPU) at different times, exerting different levels of stress on different ones of the multiple data paths. For example, the user may program the simulation module (of FIG. 1) to periodically adjust the margin values of any of the multiple data paths by a certain percentage or absolute amount of time. This may also be performed in the framework of step 302; instead of simply receiving margin values, that step may include receipt of margin values (or adjustments thereof) and instructions on when to apply them during the time horizon. The programming may be commensurate with what the user predicts to be the usage profile of the IC, which may execute different software applications at different times during its lifetime. For instance, if the IC is a CPU installed in a motor vehicle, the user may simulate the effect of a later firmware upgrade, which causes higher CPU utilization (and more activity in any of the multiple data paths) and might accelerate the degradation of the CPU. The user may do so by introducing a certain margin reduction at the day the firmware is expected to be upgraded.

Back to FIG. 3, in the simulation of steps 306 and/or 308, the effect of the operational conditions and/or the physical degradation phenomena may be calculated, inter alia, based on existing knowledge in the field of reliability in electrical engineering, as expressed, for example, in J. W. McPherson, “Reliability Physics and Engineering,” Springer (2010), which is incorporated herein by reference.

At steps 310 and 312, the simulation 308 of the margin measurement circuit may be utilized to provide a degradation curve of the IC over time, and a predicted time of failure of the IC, respectively.

Referring now to a degradation panel 220 of FIG. 2A, a degradation curve 222 may be plotted respective of the time series output by the margin measurement circuit and shown at margin measurement circuit panel 210. The exemplary degradation curve 220 shown here is non-linear, exhibiting a gradually decreasing rate of degradation. An approximately 80% degradation is reached at day 1000, and by the slope of the curve it may be deduced, even by eyeballing only, that 100% degradation (i.e., timing violation) may only be reached years later. The degradation curve may be plotted in real time during the simulation, namely, the curve may be extended over the X axis at each iteration of method 300. Of course, it is also possible to plot the entire degradation curve 222 at once, as the end of the time horizon is reached.

Reference is made to a remaining lifetime panel 224 of GUI 200, which presents one option of visualizing the predicted failure time (or, essentially, the predicted remaining lifetime) of the IC. The black curve denotes the IC's remaining lifetime in units of years (the Y axis), and the X axis of this curve shows the evolution of that lifetime prediction during the simulation's time horizon. For example, as shown, a remaining lifetime prediction (of 15 years) was first available after approximately 30 days, when enough data has been accumulated. Then, as the simulation progressed, the remaining lifetime prediction reduced to 10 years (between 250 and 500 days of simulation), then to 9 years (at 750 days), and remained at 9 years until the simulation ended at 1000 days. The gray (halftoned) ‘envelope’ shown behind the black curve denotes the confidence level of that remaining lifetime prediction at each time during the simulation. Initially, at approximately day 30, the confidence level is still relatively low, given the low amount of accumulated data, and therefore the envelope shows a relatively wide prediction of anywhere between 5 and 20 years. As time progresses, confidence grows and the envelope becomes narrower, eventually indicating a range of 7.5 to 12.5 years at day 1000.

Reference is now made to additional options of presenting the predicted failure time, shown here in a predicted failure time panel 226 of GUI 200. Here, the predicted failure time may be presented in term of years of operation until failure (e.g., 9 years, as shown), or, if the user provides a start date of the operation of the IC (e.g., Jan. 1, 2022, as shown), the predicted failure time may be provided as a date (e.g., Jan. 1, 2031, as shown). The predicted failure time panel 226 may either show the predicted failure time as the end of the time horizon is reached, or begin showing and updating it earlier, respective of degradation trend apparent from the simulation up to each point in time. For example, it may be possible to extrapolate, already at day 500 of the simulation, that the exponential shape of the degradation curve 222 so far will lead to failure in about 10 years, assuming the same operational conditions and physical degradation phenomenon remain the same.

Reference in now made to FIG. 2B, which is identical to FIG. 2A except for the aspects discussed below. Reference numbers of the same elements in these two figures are marked with an apostrophe in FIG. 2B; for example, degradation simulator 200 of FIG. 2A is marked with ′200 in FIG. 2B.

FIG. 2B demonstrates a situation in which, at day 500 of the simulation, the user made certain adjustments to the operational conditions ′202, the physical degradation phenomena ′222, and the latent defect ′216 checkbox: The temperature ′204 was increased from 50° C. to 51.5° C., the voltage ′206 was decreased from 750 mV to 749 mV, the frequency was increased from 1000 MHz to 1001 MHz, the physical degradation phenomenon ′222 was changed from NTBI to EM, and a latent defect ′216 has been selected. These changes caused degradation to accelerate, leading to failure of the IC on year 5 instead of year 9. The acceleration, beginning on day 500, is noticeable, for example, in the time series at the margin measurement circuit panel ′210, in the degradation curve panel ′222, in the remaining lifetime panel ′224, and in the predicted failure time panel ′226.

Similarly to the adjustments made by the user and shown in FIG. 2B, the user may manually or programmatically (e.g., by pre-programming what changes need occur during the simulation, and when) make any one or more adjustments to any of the operational conditions, physical degradation phenomena, and/or latent defect selection.

The simulation of method 300 may also become useful after ICs have been fabricated according to the IC design and put to use in the field. Data may be centrally collected (e.g., by a central server in network communication with ICs in the field) from operating margin measurement agents embedded in these ICs, in the form of numerical margin readings (or, as discussed above, buffer numbers that are indicative of margin ranges). Alternatively, data may be collected internally in each IC from one or more margin agents embedded in that IC. Results of the simulation (of method 300) may be stored centrally or on the individual IC (or in a computer system in which the IC is embedded), respectively. The data may either show that a particular operating IC degrades according to the simulation (of method 300), or deviates from the simulation (possibly given the way it is being utilized by different software applications, environmental conditions, operational conditions, latent defects, etc.). If the IC shows deviation from the simulation, an alert may be issued regarding any faster or slower degradation, and/or as to an updated lifetime prediction of that particular IC. The alert may be issued to a user of the IC (e.g., owner of a computing device in which the IC is installed, owner of a motor vehicle in which the IC is installed), and/or to any entity in the supply or maintenance chain of the IC, such as the IC designer or manufacturer, a system (e.g., computing device or motor vehicle) manufacturer or service provider, etc.

For example, if an IC installed in a computerized system of a motor vehicle exhibits faster degradation than originally simulated, an alert may be issued to a driver of the vehicle, to a service center where the vehicle is under warranty, to a fleet manager to which the vehicle belongs, to a manufacturer of the vehicle, to a manufacturer of the computerized system in which the IC is embedded, and/or to a manufacturer of the IC itself. Such alert may be issued in real time, immediately upon the IC or the central server discovers that degradation is faster than originally simulated, or be packaged together with other alerts that are issued on a periodic basis. In response to the alert, any of the aforementioned entities may take preventative measures, such as updating software and/or firmware of the computerized system in order to reduce the load on the IC and slow down its degradation. Alternatively, for example if the degradation is extremely fast, the vehicle may be recalled and the IC (or even the entire computer system in which it is embedded) be proactively replaced in order to prevent upcoming failure of the vehicle.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range-10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

1. A computer-implemented method comprising:
receiving timing data of multiple data paths of an integrated circuit (IC) design;
simulating degradation of the multiple data paths over a period of time, wherein the timing data serve as a baseline of the simulated degradation, and wherein the simulation comprises:
simulating effects of operational conditions on the multiple data paths, wherein the operational conditions comprise: temperature, voltage, and frequency,
simulating an effect of at least one physical degradation phenomenon on the multiple data paths, wherein the at least one physical degradation phenomenon is selected from the group consisting of: negative-bias temperature instability (NBTI), hot carrier injection (HCI), electromigration (EM), and time-dependent dielectric breakdown (TDDB), and
simulating operation of a margin measurement circuit which is embedded in the IC design and monitors the multiple data paths, wherein the margin measurement circuit, in the simulated operation, outputs a time series of values of a worst-case remaining margin of the multiple data paths; and
based on the simulated degradation, estimating at least one of:
a degradation curve of the multiple data paths over the period of time, or
a predicted time of failure of the IC design due to a timing violation by a worst-performing data path of the multiple data paths.

2. The computer-implemented method of claim 1, wherein the margin measurement circuit comprises:
a signal combiner configured to combine signals from the multiple data paths;
a signal splitter configured to split the combined signals into two test paths;
a delay circuit configured to gradually apply varying levels of delay to signals passing through a first one of the two test paths;
a comparation circuit configured to determine the worst-case remaining margin of the multiple data paths, based on a comparison between the first test path and a second one of the two test paths.

3. The computer-implemented method of claim 1, further comprising:
receiving values of the operational conditions from a user.

4. The computer-implemented method of claim 3, wherein:
the receiving of the values of the operational conditions receiving comprises:
receiving different values of at least one of the operational conditions, and
receiving a selection of different points in time, during the period of time, at which the different values, respectively, are to be applied; and
the computer-implemented method further comprises applying the different values at the selected different point in time during the simulation of the operational conditions.

5. The computer-implemented method of claim 1, further comprising:
receiving a selection of the at least one physical degradation phenomenon from a user,
wherein the simulating of the effect of the at least one physical degradation phenomenon is based on the selection.

6. The computer-implemented method of claim 5, wherein:
the selection of the at least one physical degradation phenomenon comprises:
a selection of multiple ones of the physical degradation phenomena, and
a selection of different points in time, during the period of time, at which each of the multiple ones of the physical degradation phenomena, respectively, is to be applied; and
the computer-implemented method further comprises applying the multiple ones of the physical degradation phenomena at the selected different point in time during the simulating of the effect of the multiple ones of the physical degradation phenomena.

7. The computer-implemented method of claim 1, wherein:
the values of the worst-case remaining margin, which are output by the margin measurement circuit, are each given as a range of worst-case remaining margins.

8. The computer-implemented method of claim 1, wherein the simulation of the degradation further comprises:
simulating execution by the IC of different software applications at different times, by periodically adjusting one or more margin values of one or more of the multiple data paths, respectively.

9. The computer-implemented method of claim 1, further comprising, based on the simulated degradation:
adjusting one or more of the multiple data paths in the IC design, to increase or decrease the margin of the one or more data paths.

10. The computer-implemented method of claim 1, further comprising, based on the simulated degradation:
receiving data from a margin measurement circuit embedded in an operating IC that was fabricated according to the IC design; and
based on the simulated degradation and on the received data, performing at least one of:
estimating deviation of actual degradation of the operating IC from the simulated degradation,
updating a degradation estimation of the operating IC, or
issuing an alert based on an estimated deviation of actual degradation of the operating IC from the simulated degradation.

11. The computer-implemented method of claim 1, further comprising:
in a Dynamic Voltage and Frequency Scaling (DVFS) system of an IC fabricated according to the IC design, configuring parameters of the DVFS system based on the simulated degradation.

12. The computer-implemented method of claim 11, wherein the configuring of the parameters is performed:
between when the IC is fabricated and when the IC is released for field operations; and/or
during field operation of the IC, at a time determined in advance based on the simulated degradation.

13. A system comprising:
(a) at least one hardware processor; and
(b) a non-transitory computer-readable storage medium having program code embodied therewith, the program code executable by said at least one hardware processor to:
receive timing data of multiple data paths of an integrated circuit (IC) design;
automatically simulate degradation of the multiple data paths over a period of time, wherein the timing data serve as a baseline of the simulated degradation, and wherein the simulation comprises:
simulating effects of operational conditions on the multiple data paths, wherein the operational conditions comprise: temperature, voltage, and frequency,
simulating an effect of at least one physical degradation phenomenon on the multiple data paths, wherein the at least one physical degradation phenomenon is selected from the group consisting of: negative-bias temperature instability (NBTI), hot carrier injection (HCI), electromigration (EM), and time-dependent dielectric breakdown (TDDB), and
simulating operation of a margin measurement circuit which is embedded in the IC design and monitors the multiple data paths, wherein the margin measurement circuit, in the simulated operation, outputs a time series of values of a worst-case remaining margin of the multiple data paths; and
based on the simulated degradation, estimating at least one of:
a degradation curve of the multiple data paths over the period of time, or
a predicted time of failure of the IC design due to a timing violation by a worst-performing data path of the multiple data paths.

14. The system of claim 13, wherein the margin measurement circuit comprises:
a signal combiner configured to combine signals from the multiple data paths;
a signal splitter configured to split the combined signals into two test paths;
a delay circuit configured to gradually apply varying levels of delay to signals passing through a first one of the two test paths;
a comparation circuit configured to determine the worst-case remaining margin of the multiple data paths, based on a comparison between the first test path and a second one of the two test paths.

15. The system of claim 13, wherein the program code is further executable to:
receive values of the operational conditions from a user.

16. The system of claim 14, wherein:
the receiving of the values of the operational conditions receiving comprises:
receiving different values of at least one of the operational conditions, and
receiving a selection of different points in time, during the period of time, at which the different values, respectively, are to be applied; and
the program code is further executable to apply the different values at the selected different point in time during the simulation of the operational conditions.

17. The system of claim 13, wherein the program code is further executable to:
receive a selection of the at least one physical degradation phenomenon from a user,
wherein the simulating of the effect of the at least one physical degradation phenomenon is based on the selection.

18. The system of claim 17, wherein:
the selection of the at least one physical degradation phenomenon comprises:
a selection of multiple ones of the physical degradation phenomena, and
a selection of different points in time, during the period of time, at which each of the multiple ones of the physical degradation phenomena, respectively, is to be applied; and
the program code is further executable to apply the multiple ones of the physical degradation phenomena at the selected different point in time during the simulating of the effect of the multiple ones of the physical degradation phenomena.

19. The system of claim 13, wherein:
the values of the worst-case remaining margin, which are output by the margin measurement circuit, are each given as a range of worst-case remaining margins.

20. The system of claim 13, wherein the simulation of the degradation further comprises:
simulating execution by the IC of different software applications at different times, by periodically adjusting one or more margin values of one or more of the multiple data paths, respectively.

21. The system of claim 13, wherein the program code is further executable, based on the simulated degradation, to:
adjust one or more of the multiple data paths in the IC design, to increase or decrease the margin of the one or more data paths.

22. The system of claim 13, wherein the program code is further executable, based on the simulated degradation, to:
receive data from a margin measurement circuit embedded in an operating IC that was fabricated according to the IC design; and
based on the simulated degradation and on the received data, performing at least one of:
estimating deviation of actual degradation of the operating IC from the simulated degradation,
update a degradation estimation of the operating IC, or
issuing an alert based on an estimated deviation of actual degradation of the operating IC from the simulated degradation.

23. The system of claim 13, wherein the program code is further executable to:
in a Dynamic Voltage and Frequency Scaling (DVFS) system of an IC fabricated according to the IC design, configure parameters of the DVFS system based on the simulated degradation.

24. The system of claim 23, wherein the configuring of the parameters is performed:
between when the IC is fabricated and when the IC is released for field operations; and/or
during field operation of the IC, at a time determined in advance based on the simulated degradation.

25. A computer program product comprising a non-transitory computer-readable storage medium having program code embodied therewith, the program code executable by at least one hardware processor to:
receive timing data of multiple data paths of an integrated circuit (IC) design;
automatically simulate degradation of the multiple data paths over a period of time, wherein the timing data serve as a baseline of the simulated degradation, and wherein the simulation comprises:
simulating effects of operational conditions on the multiple data paths, wherein the operational conditions comprise: temperature, voltage, and frequency,
simulating an effect of at least one physical degradation phenomenon on the multiple data paths, wherein the at least one physical degradation phenomenon is selected from the group consisting of: negative-bias temperature instability (NBTI), hot carrier injection (HCI), electromigration (EM), and time-dependent dielectric breakdown (TDDB), and
simulating operation of a margin measurement circuit which is embedded in the IC design and monitors the multiple data paths, wherein the margin measurement circuit, in the simulated operation, outputs a time series of values of a worst-case remaining margin of the multiple data paths; and
based on the simulated degradation, estimating at least one of:
a degradation curve of the multiple data paths over the period of time, or
a predicted time of failure of the IC design due to a timing violation by a worst-performing data path of the multiple data paths.

26. The computer program product of claim 25, wherein the margin measurement circuit comprises:
a signal combiner configured to combine signals from the multiple data paths;
a signal splitter configured to split the combined signals into two test paths;
a delay circuit configured to gradually apply varying levels of delay to signals passing through a first one of the two test paths;
a comparation circuit configured to determine the worst-case remaining margin of the multiple data paths, based on a comparison between the first test path and a second one of the two test paths.

27. The computer program product of claim 25, wherein the program code is further executable to:
receive values of the operational conditions from a user.

28. The computer program product of claim 27, wherein:
the receiving of the values of the operational conditions receiving comprises:
receiving different values of at least one of the operational conditions, and
receiving a selection of different points in time, during the period of time, at which the different values, respectively, are to be applied; and
the program code is further executable to apply the different values at the selected different point in time during the simulation of the operational conditions.

29. The computer program product of claim 25, wherein the program code is further executable to:
receive a selection of the at least one physical degradation phenomenon from a user,
wherein the simulating of the effect of the at least one physical degradation phenomenon is based on the selection.

30. The computer program product of claim 29, wherein:
the selection of the at least one physical degradation phenomenon comprises:
a selection of multiple ones of the physical degradation phenomena, and
a selection of different points in time, during the period of time, at which each of the multiple ones of the physical degradation phenomena, respectively, is to be applied; and
the program code is further executable to apply the multiple ones of the physical degradation phenomena at the selected different point in time during the simulating of the effect of the multiple ones of the physical degradation phenomena.

31. The computer program product of claim 25, wherein:
the values of the worst-case remaining margin, which are output by the margin measurement circuit, are each given as a range of worst-case remaining margins.

32. The computer program product of claim 25, wherein the simulation of the degradation further comprises:
simulating execution by the IC of different software applications at different times, by periodically adjusting one or more margin values of one or more of the multiple data paths, respectively.

33. The computer program product of claim 25, wherein the program code is further executable, based on the simulated degradation, to:
adjust one or more of the multiple data paths in the IC design, to increase or decrease the margin of the one or more data paths.

34. The computer program product of claim 25, wherein the program code is further executable, based on the simulated degradation, to:
receive data from a margin measurement circuit embedded in an operating IC that was fabricated according to the IC design; and
based on the simulated degradation and on the received data, performing at least one of:
estimating deviation of actual degradation of the operating IC from the simulated degradation,
updating a degradation estimation of the operating IC, or
issuing an alert based on an estimated deviation of actual degradation of the operating IC from the simulated degradation.

35. The computer program product of claim 25, wherein the program code is further executable to:
in a Dynamic Voltage and Frequency Scaling (DVFS) system of an IC fabricated according to the IC design, configure parameters of the DVFS system based on the simulated degradation.

36. The computer program product of claim 35, wherein the configuring of the parameters is performed:
between when the IC is fabricated and when the IC is released for field operations; and/or
during field operation of the IC, at a time determined in advance based on the simulated degradation.

37. (canceled)

38. (canceled)

39. (canceled)
